(19) United States
(12) Patent Application Publication
(10) Pub. No.: US 2019/0283797 A1
(43) Pub. Date: Sep. 19, 2019

(54) RACK-AND-PINION STEERING SYSTEM COMPRISING A ONE-PIECE TRANSMISSION HOUSING

(71) Applicants: THYSSENKRUPP PRESTA AG, Eschen (LI); thyssenkrupp AG, Essen (DE)

(72) Inventors: Philippe STECK, Eschen (LI); Patrick BAUMGARTNER, St. Gallen (CH)

(73) Assignees: THYSSENKRUPP PRESTA AG, Eschen (LI); thyssenkrupp AG, Essen (DE)

(21) Appl. No.: 16/344,551

(22) PCT Filed: Nov. 8, 2017
(86) PCT No.: PCT/EP2017/078540

§ 371 Date: Apr. 24, 2019

(30) Foreign Application Priority Data
Nov. 9, 2016 (DE) 10 2016 013 270.1

(51) Int. Cl. B62D 5/04; B62D 3/12; F16H 57/039

(52) U.S. Cl. CPC B62D 5/0403; B62D 3/12; F16H 2057/02034; F16H 57/039; B62D 5/0421

(57) ABSTRACT

A rack and pinion steering system for a motor vehicle may include a pinion shaft that is connected to a steering shaft and includes a steering pinion that is engaged with a rack that is mounted in a gear housing such that the rack can be displaced along a longitudinal axis for pivoting steerable wheels. The rack and pinion steering system may also include an electric motor that drives the pinion shaft via a step-down gear mechanism. An overall arrangement of the rack, the pinion shaft, and the step-down gear mechanism may be received in the gear housing. Further, the gear housing may be a single-piece gear housing.

The present invention relates to a rack and pinion steering system for a motor vehicle having the features of the preamble of claim 1.

Rack and pinion steering systems of the generic type have a rack which is guided in a linearly movable manner in a gear housing, and a rotatably mounted steering pinion which is in engagement with the rack. The steering torque which is exerted on a steering wheel by a driver is transmitted via a steering shaft to an input shaft of the steering gear. The input shaft of the steering gear is connected to a steering pinion which meshes with the rack. A rotation of the input shaft and the steering pinion is converted via the tooth engagement of the rack into a linear movement of the rack. Track rods are articulated on the rack, with the aid of which track rods the steered wheels are adjusted by a wheel lock angle. The rotation of the steering wheel is thus converted into a steering movement of the steered wheels. In the case of electrically assisted rack and pinion steering systems, a servomotor is provided which acts, for example, by means of a mechanical step-down gear mechanism with a worm and a worm gear on the steering pinion and thus assists the driver during a steering maneuver.

Laid open specification DE 10 2011 001 217 A1 discloses a steering system which has an electric steering drive, the rotational movements of which are transmitted via a step-down gear mechanism to a steering linkage. The steering system has a multiple-piece housing, the housing parts of which surround both the steering linkage, the worm gear mechanism and the steering drive. Here, the drive gear housing part which surrounds the worm gear mechanism and the steering gear housing part which surrounds the steering linkage are connected to one another via screw connections. A sealing ring is arranged in the contact region between the two housing parts, with the result that the penetration of moisture and dust from the surroundings into the housing can be avoided. A dirt seal of this type in a greatly corrosive environment is not considered to be sufficient, however.

DE 233657 A1 has disclosed a rack drive unit which has a housing which is assembled from at least two parts, a section for the pinion housing and a section for the rack housing being provided which are joined together and are connected to one another to form a unitary housing. This construction proves problematic in that a very accurate fit of the housing halves is required. Slight warping of the housing parts leads to a gap being formed, in which dirt is collected.

It is therefore an object of the present invention to specify a rack and pinion steering system for a motor vehicle having a gear housing which is sealed satisfactorily with respect to the surroundings in a structurally simple way.

Accordingly, a rack and pinion steering system for a motor vehicle is provided comprising a pinion shaft which is connected to a steering shaft and has a steering pinion which is in engagement with a rack which is mounted in a gear housing such that it can be displaced along a longitudinal axis for pivoting steerable wheels, and having an electric motor which drives the pinion shaft via a step-down gear mechanism, the rack, the pinion shaft and the step-down gear mechanism forming an overall arrangement, the overall arrangement being received in the gear housing, and the gear housing being configured in one piece. As a result of the single-piece configuration of the gear housing, a seal between the steering gear housing and the drive gear housing can be dispensed with.

It is preferred if, at its end which is close to the steering shaft, the pinion shaft is connected to a torsion bar which connects the pinion shaft to an input shaft, the torsion bar being part of a torque sensor which determines the steering torque which is applied at the steering wheel and is required for actuating the electric motor, and the torque sensor likewise being received in the single-piece gear housing. The single-piece housing is less expensive and also considerably lighter in comparison with conventional multiple-piece housings.

The step-down gear mechanism is preferably arranged at an end of the pinion shaft, which end is remote from the steering shaft. It is preferred here if the step-down gear mechanism and the electric motor are arranged on the opposite side of the rack with respect to the torque sensor. This configuration has the advantage that the step-down gear mechanism is arranged closer to the roadway, to be precise below the rack, and is therefore separated spatially from the contamination-sensitive sensor region of the torque sensor.

Furthermore, it is advantageous if the step-down gear mechanism is a worm gear mechanism, a worm gear of the worm gear mechanism surrounding the pinion shaft concentrically and being connected fixedly to the latter so as to rotate with it.

The pinion shaft is preferably mounted rotatably in a bearing in the single-piece gear housing.

It is preferred if the single-piece gear housing is a cast housing made from aluminum or magnesium or plastic.

Two preferred embodiments of the invention will be described in greater detail in the following text using the drawings. Identical or identically acting components are denoted by the same designations in the figures, in which:

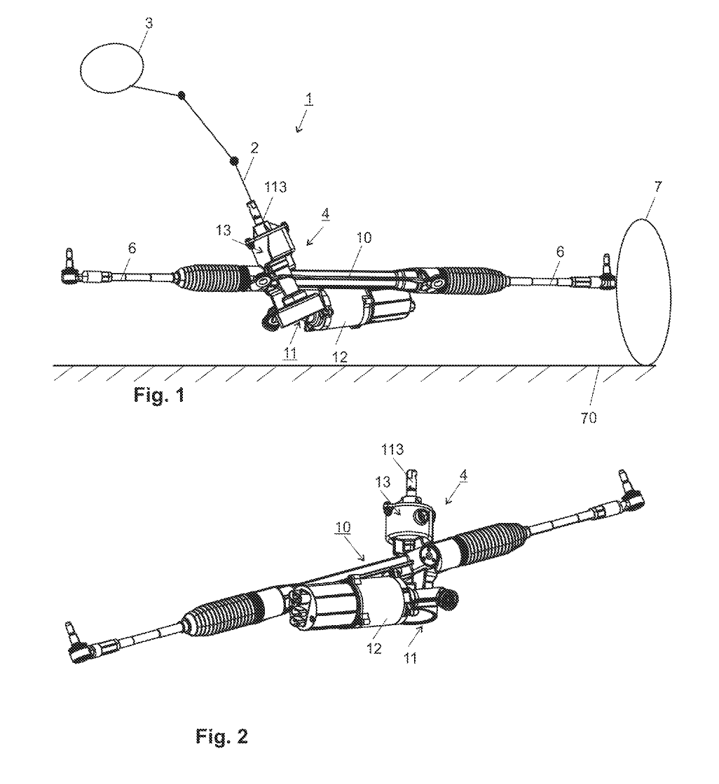

FIG. 1 shows a diagrammatic illustration of a rack and pinion steering system,

FIG. 2 shows a three-dimensional view of the steering gear from FIG. 1,

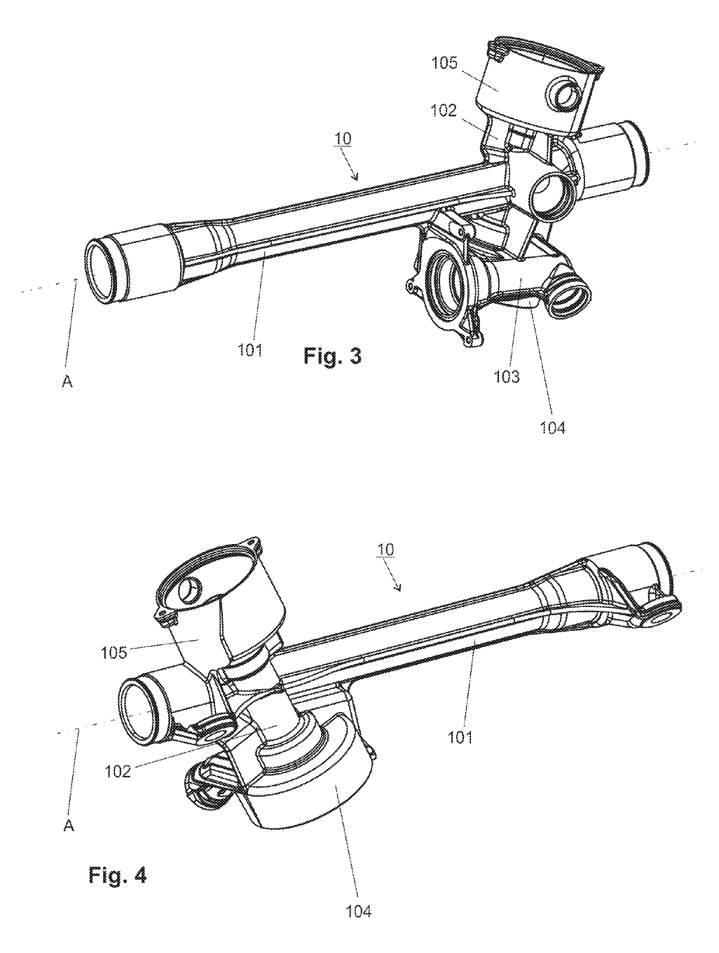

FIG. 3 shows a first three-dimensional illustration of the housing of the steering gear from FIG. 1,

FIG. 4 shows a second three-dimensional illustration of the housing of the steering gear from FIG. 1,

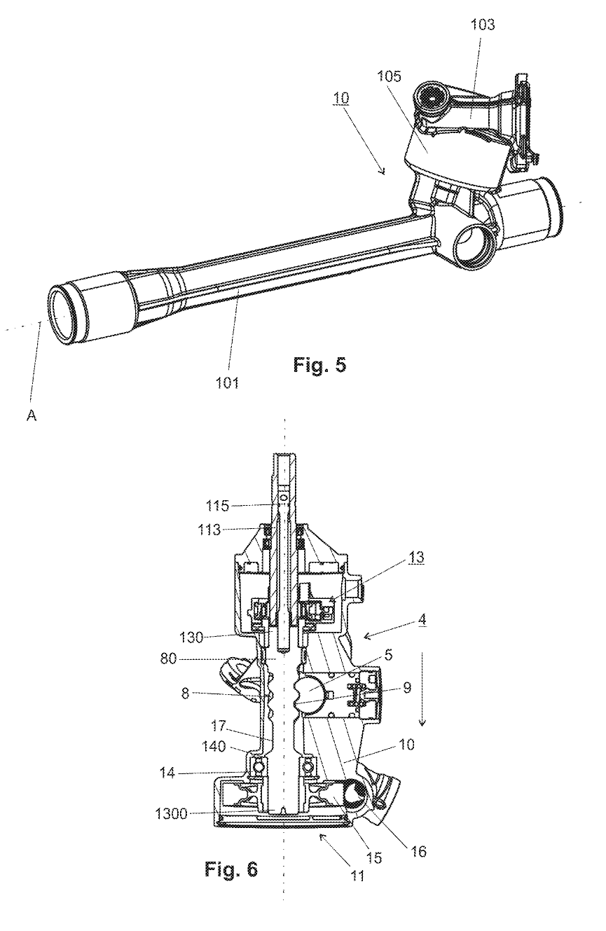

FIG. 5 shows a three-dimensional view of a housing in accordance with a second embodiment, and

FIG. 6 shows a longitudinal section of the rack and pinion steering system.

FIG. 1 diagrammatically shows a rack and pinion steering system 1 of a motor vehicle. A steering shaft 2 serves for the transmission of the steering movements which are carried out at the steering wheel 3 by a driver of the motor vehicle to a rack and pinion steering gear 4. The rack and pinion steering gear 4 converts the rotational movement of the steering shaft 2 into a movement of a rack 5, as a result of which a wheel 7 of the vehicle, which wheel 7 is articulated on a track rod 6, carries out a steering lock movement. The rotational movement of the steering shaft 2 is converted into a translational movement of the rack 5 via a steering pinion 8 which meshes with the rack 5 in a toothing region. The rack 5 is mounted in an axially movable manner in a first section of a gear housing 10. A step-down gear mechanism 11 and an electric servomotor 12 are arranged on a side of the rack 5, which side is remote from the steering shaft. The servomotor 12 acts via the step-down gear mechanism 11 on the steering pinion 8 for steering assistance. The steering pinion 8 is arranged on a pinion shaft 80 which has an end 130 which is close to the steering shaft and an end 1300 which is remote from the steering shaft. As shown in FIG. 6, the end 130 which is close to the steering shaft is connected to a torsion bar 115 which connects the pinion shaft 80 to an input shaft 113 which is in turn connected fixedly to the steering wheel 3 so as to rotate with it via the steering shaft 2. The torsion bar 115 brings about a relative rotation between the input shaft 113 and the pinion shaft 80 in a manner which is dependent on the steering wheel torque. The torsion bar 115 is part of a torque sensor 13 which determines the steering torque which is applied at the steering wheel 3 and is required for actuating the electric motor 12. The pinion shaft 80 is mounted rotatably in a bearing 14 in a second section of the gear housing 10 between the steering pinion 8 and the end 1300 which is remote from the steering shaft. The pinion shaft 80 has a tapered portion 17 between the steering pinion 8 and the bearing 14, the diameter of which tapered portion 17 is smaller than that of the steering pinion 8 and a bearing seat 140 of the bearing 14 or than the remaining diameter of the pinion shaft 80. The tapered portion 17 preferably adjoins the steering pinion 8 directly. A worm gear 15 of the step-down gear mechanism 11 is provided at that end 1300 of the pinion shaft 80 which is remote from the steering shaft, which worm gear 15 surrounds the pinion shaft 80 concentrically and is connected fixedly to the latter so as to rotate with it. The electric servomotor 12 drives a worm shaft 16 which meshes with the worm gear 15 which is arranged on the pinion shaft 80. The worm shaft 16 and the worm gear 15 are surrounded by a third and fourth section of the gear housing 10. In addition, the gear housing 10 receives the torque sensor 13 in a fifth section.

Since the worm gear mechanism is arranged at that end 1300 of the pinion shaft 80 which is remote from the steering shaft and is therefore arranged so as to lie below the pinion, the servomotor can likewise be attached on the underside of the steering gear, which is particularly space-saving. Here, the underside is to be understood to mean that side of the steering gear 4 in the direction of the roadway 70.

The tapered portion of the pinion shaft simplifies the assembly of the steering gear in such a way that the rack 5 can be pushed past the pinion shaft 80 in the region of the tapered portion 17. After the rack 5 has been received in the transmission housing 10, the pinion shaft 80 is pressed downward in the direction of the roadway 70, in order to bring the steering pinion 8 into engagement with the toothing system 9 of the rack 5.

FIG. 2 shows a second view of the position of the step-down gear mechanism 11 and the servomotor 12 below the rack 5, that is to say so as to lie closer to the roadway 70, with the gear housing 10.

FIGS. 3 and 4 show two different views of the gear housing 10. The gear housing 10 is configured in one piece. Sealing points can thus be avoided. The gear housing 10 has the first section 101, the second section 102, the third section 103, the fourth section 104 and the fifth section 105. In the first section 101, the rack 5 is mounted such that it can be displaced along a longitudinal axis A. In the fifth section 105, the input shaft 113 is received with the torsion bar 115. The fifth section 105 merges into the second section 102, in which the pinion shaft 80 is mounted rotatably with the steering pinion. The second section 102 merges into the fourth section 104, in which the worm gear 15 is arranged. The worm shaft 16 which meshes with the worm gear 15 is provided in the third section 103. The third section 103 is approximately parallel to the first section 101. As shown in FIG. 5, the third section 103 can merge into the fifth section 105, with the result that the third section lies with the step-down gear mechanism above the rack 5 and is therefore arranged at a greater spacing from the roadway 70. In particular, the sealing point between the third and the fourth section 103, 104, the drive gear housing, and the first and second section 101, 102, the steering gear housing, is dispensed with. As a result of the arrangement of the step-down gear mechanism below the rack, the contamination-sensitive sensor region of the torque sensor is separated spatially from the greased region of the step-down gear mechanism. In addition, a single-piece housing can be produced very cost-efficiently and provides a considerable weight saving.

The gear housing 10 is preferably a cast housing made from aluminum or magnesium or plastic.

FIG. 5 shows a further embodiment of the gear housing 10. The step-down gear mechanism 11 is arranged in the region of the torque sensor 13 or in the immediate vicinity of the torque sensor 13, and is operatively connected to the pinion shaft between the input shaft and the steering pinion. The single-piece gear housing 10 also has both the drive gear housing and the steering gear housing here.

1.-7. (canceled)

8. A rack and pinion steering system for a motor vehicle comprising:
a pinion shaft that is connected to a steering shaft and includes a steering pinion engaged with a rack that is mounted in a single-piece gear housing such that the rack is displaceable along a longitudinal axis for pivoting steerable wheels; and
an electric motor that drives the pinion shaft via a step-down gear mechanism,
wherein the rack, the pinion shaft, and the step-down gear mechanism are received in the single-piece gear housing.

9. The rack and pinion steering system of claim 8 wherein the step-down gear mechanism is disposed at an end of the pinion shaft that is distal the steering shaft.

10. The rack and pinion steering system of claim 8 wherein an end of the pinion shaft that is proximate the steering shaft is connected to a torsion bar that connects the pinion shaft to an input shaft, with the torsion bar being part of a torque sensor that determines a steering torque applied at a steering wheel and is required for actuating the electric motor, wherein the torque sensor is received in the single-piece gear housing.

11. The rack and pinion steering system of claim 10 wherein the step-down gear mechanism and the electric motor are disposed on an opposite side of the rack with respect to the torque sensor.

12. The rack and pinion steering system of claim 8 wherein the step-down gear mechanism is a worm gear mechanism, wherein a worm gear of the worm gear mechanism surrounds the pinion shaft concentrically and is connected fixedly to the pinion shaft so as to rotate with the pinion shaft.

13. The rack and pinion steering system of claim 8 wherein the pinion shaft is mounted rotatably in a bearing in the single-piece gear housing.

14. The rack and pinion steering system of claim 8 wherein the single-piece gear housing is a cast housing comprised of aluminum.

15. The rack and pinion steering system of claim 8 wherein the single-piece gear housing is a cast housing comprised of magnesium.

16. The rack and pinion steering system of claim 8 wherein the single-piece gear housing is a cast housing comprised of plastic.
